(19) United States
(12) Patent Application Publication
(10) Pub. No.: US 2024/0119918 A1
(43) Pub. Date: Apr. 11, 2024

(54) AUTOMATIC PERFORMING APPARATUS AND AUTOMATIC PERFORMING PROGRAM

(71) Applicant: KABUSHIKI KAISHA KAWAI GAKKI SEISAKUSHO, Hamamatsu-shi (JP)

(72) Inventor: Masanori KATSUTA, Hamamatsu-shi (JP)

(73) Assignee: KABUSHIKI KAISHA KAWAI GAKKI SEISAKUSHO, Hamamatsu-shi (JP)

(21) Appl. No.: 18/375,632

(22) Filed: Oct. 2, 2023

(30) Foreign Application Priority Data
Oct. 3, 2022 (JP) 2022-159205

(51) Int. Cl. G10H 1/00

(52) U.S. Cl. CPC G10H 1/0025; G10H 2210/381

(57) ABSTRACT

An automatic performing apparatus being an automatic performing apparatus that automatically performs performance data segmented into a plurality of performance sections, the apparatus includes: a first automatic performing unit configured to perform automatic performance of the performance data in a first performance section at a first tempo in response to an input of a first external event; and a second automatic per unit configured to, when a second external event is input before the automatic performance in the first performance section is finished, continue the automatic performance in the first performance section at a second tempo different from the first tempo, the second automatic performing unit configured to, when the automatic performance in the first performance section is finished, perform automatic performance of the performance data in a second performance section at a third tempo.

### CROSS-REFERENCE TO RELATED APPLICATIONS

This application is based upon and claims the benefit of priority of the prior Japanese Patent. Application No. 2022-159205, filed on Oct. 3, 2022, the entire contents of which are incorporated herein by reference.

### BACKGROUND OF THE INVENTION

### Field of the Invention

The present invention relates to an automatic performing apparatus and an automatic performing program.

### Description of the Related Art

Patent Document 1 has described an automatic performing apparatus that automatically performs song data in response to external events. The song data are segmented into respective performance sections by predetermined section data. The section data are located at the beginning of the section. During the automatic performance, the song data are automatically performed from the beginning to the end of a predetermined section in response to an external event. During the automatic performance, according to the external event, the automatic performance the section corresponding to the external event progresses sequentially one section at a time. When an external event is provided, the automatic performing apparatus sets the tempo of the automatic performance in the section corresponding to the current external event using the tempo of the automatic performance in the immediately preceding section, the value stored in advance as an assumed value of the number of clocks in the immediately preceding section, and the actual measured value of the number of clocks between the previous external event and the current external event.

Patent. Document 2 has described a tempo controller including a tempo clock information output means that outputs tempo clock information based on the progression of a musical score time, which represents the progression position on a musical score, in order to automatically output a musical tone of performance data sequentially.

[Patent Document 1] Japanese Patent No. 180868

[Patent Document 2] Japanese Patent No. 2653232

In the case of Patent Document 1, when a key is pressed before automatic performance reaches the end of each performance section, the performance position jumps to the beginning of the next performance section at once to continue the performance. Therefore, there is a problem that the musical tones in the section up to the jump destination are skipped without being generated, and the automatic performance proceeds ahead. This problem is particularly noticeable when switching the tempo from a slow tempo to a fast tempo.

Moreover, the tempo after the jump suddenly increases, and the automatic performance immediately reaches up to the end of the performance section, thus causing the automatic performance to pause at a timing earlier than expected by an operator. Feeling that this pause is unnatural, the operator hurriedly presses the next key in order to release it quickly. As a result, the tempo becomes faster and faster because the operator presses the keys earlier and earlier. If the timing at which the key is pressed is delayed in order to break this vicious cycle, the automatic performance pauses unnaturally this time conversely. There is also a problem that this repetitive jumping and pausing causes awkward and unnatural performances against the operator's will. In particular, this problem is noticeable in a staircase of musical tones or the like that spans a plurality of performance sections.

The above problems may not seem like a big deal, but they are actually important points for the performance. The operator feels comfortable when the automatic performance progresses smoothly and at will according to his or her own key-press control, which makes the operator possible to feel intoxicated by the feeling of being a performer for the first time.

In the case of Patent Document 1, however, if the key is pressed earlier than the end of the performance section, musical tones are thinned out and jump suddenly, and if the key is pressed later than the end of the performance section, the automatic performance pauses. Therefore, far from being comfortable with smooth automatic performance, the awkward and unintentional performance causes a lot of stress. To prevent the above, it is also possible to perform control to prevent the musical tones from being thinned out and cause few pauses, but this will result in a boring automatic performance that is almost the same as the original song.

The above problem can be understood easily by comparing it to a car racing game. When the car is too responsive to a steering wheel operation, a slight turn of a steering wheel in response to a curve causes the car to turn in the direction of travel tighter than the curve. When the steering wheel is turned in the opposite direction to correct the situation, the car turns too far in the opposite direction this time. This repetition makes it difficult to set the steering wheel operation, and the car swings from side to side, which is frustrating. The above is the same as this. In short, when the response to key pressing is too quick, controlling the performance is difficult conversely.

On the other hand, when it is desired to restart the automatic performance after a short time provided between the end of the performance section and the beginning of the next performance section, a pause is provided at the end of the performance section and then a key is pressed after a short time. However, doing so causes the tempo of the next performance section to slow down to an extremely low level. Then, when keys are pressed very early to speed up the tempo, the musical tones are thinned out and jump ahead. This is also a problem that results in unnatural performance against the operator's will.

### SUMMARY OF THE INVENTION

An object of the present invention is to enable, when an external event is input before automatic performance in a performance section is finished, the automatic performance in the performance section to continue at an appropriate tempo.

The automatic performing apparatus is an automatic performing apparatus that automatically performs performance data segmented into a plurality of performance sections, the apparatus including: a first automatic performing unit configured to perform automatic performance of the performance data in a first performance section at a first tempo in response to an input of a first external event; and a second automatic performing unit configured to, when a second external event is input before the automatic performance in the first performance section is finished, continue the automatic performance in the first performance section at a second tempo different from the first tempo, the second automatic performing unit configured to, when the automatic performance in the first performance section is finished, perform automatic performance of the performance data in a second performance section at a third tempo.

### BRIEF DESCRIPTION OF THE DRAWINGS

FIG. 1 is a diagram illustrating a configuration example of an automatic performing apparatus according to this embodiment;

FIG. 2A and FIG. 2B each are a view illustrating a display example of a timing of a keyboard event;

FIG. 3 is a view illustrating an example of a ROM in which a plurality of performance data are stored;

FIG. 4A and FIG. 4B each are a view illustrating a configuration example of performance data;

FIG. 5 is a view illustrating a display example of a piano roll during first to fourth performance sections;

FIG. 6 is a flowchart illustrating a main routine of processing of the automatic performing apparatus;

FIG. 7 is a flowchart illustrating details of panel event processing;

FIG. 8 is a flowchart illustrating details of keyboard event processing;

FIG. 9 is a flowchart illustrating details of automatic performance event processing;

FIG. 10 is a flowchart illustrating details of tonal volume setting processing;

FIG. 11 is a view illustrating a processing example when the interval between key pressing events is the same as a performance time;

FIG. 12A and FIG. 12B are views illustrating processing examples when the interval between the key pressing events is longer than the performance time;

FIG. 13 is a view illustrating a processing example when the interval between the key pressing events is shorter than the performance time; and

FIG. 14 is a view illustrating an example of a piano roll to be displayed on a touch panel.

### DETAILED DESCRIPTION OF THE PREFERRED EMBODIMENTS

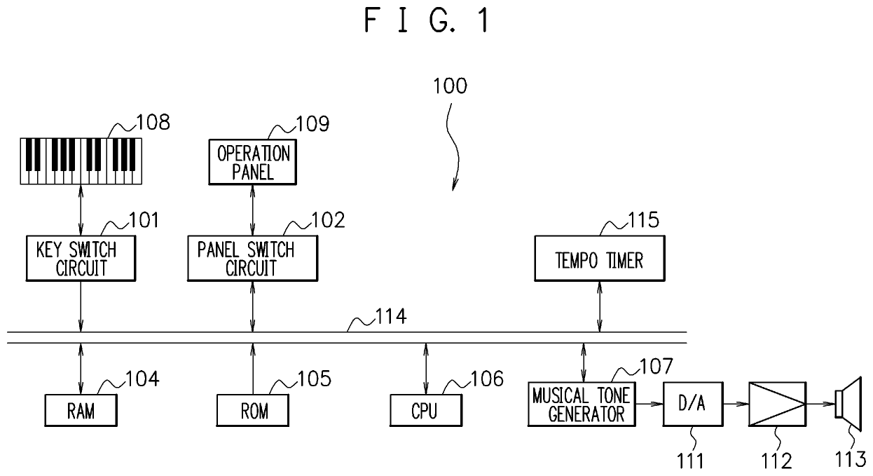

FIG. 1 is a diagram illustrating a configuration example of an automatic performing apparatus 100 according to this embodiment. The automatic performing apparatus 100 is an electronic musical instrument, a personal computer, a tablet, a smartphone, or the like. There is explained, as an example, the case where the automatic performing apparatus 100 is an electronic musical instrument below. The automatic performing apparatus 100 includes a keyboard 108, a key switch circuit 101 that detects an operational state of the keyboard 108, an operation panel 109, a panel switch circuit 102 that detects an operational state of the operation panel 109, a RAM 104, a ROM 105, a CPU 106, a tempo timer 115, and a musical tone generator 107, which are all coupled by a bus 114. A digital/analog (D/A) converter 111, an amplifier 112, and a speaker 113 are serially connected to the musical tone generator 107.

The operation panel 109 includes a mode selection switch. When a normal performance mode is selected in the mode selection switch, the automatic performing apparatus 100 functions as a normal electronic musical instrument, and when an automatic performance mode is selected, the automatic performing apparatus 100 functions as an automatic performing apparatus. The operation panel 109 includes a song selection switch. By the song selection switch, a song to be automatically performed can be selected. Further, the operation panel 109 includes an indicator 109a that displays the timing of a keyboard event (pressing any key of the keyboard 108; an external event) for the keyboard 108 when performing automatic performance.

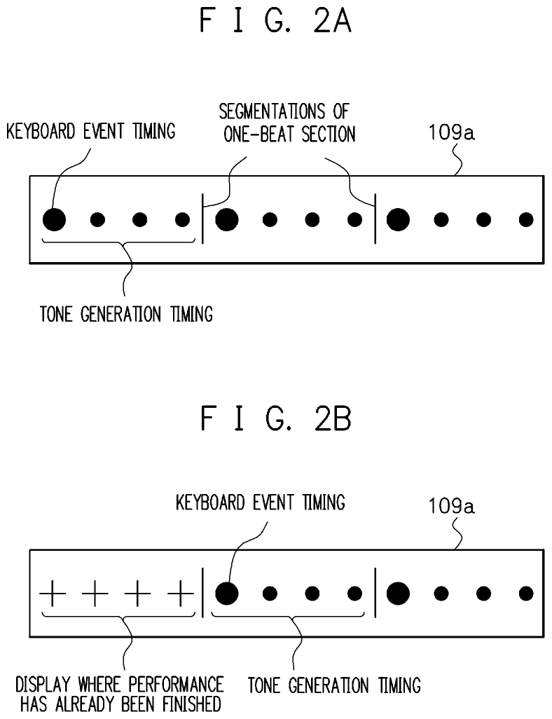

As illustrated in FIG. 2A, the indicator 109a displays the timing at which a keyboard event should be provided in the automatic performance with a large black circle and in addition to the timing of the keyboard event, displays the timing of note data whose tone is generated in response to a keyboard event with a small black circle. Further, the indicator 109a displays segmentations of one-beat section, and displays the timing of a keyboard event whose automatic performance has already been finished and the timing of note data whose tone has been generated as a cross mark, as illustrated in FIG. 2B.

The tempo timer 115 supplies an interrupting signal to the CPU 106 at certain intervals during automatic performance, and serves as a reference for the tempo of automatic performance.

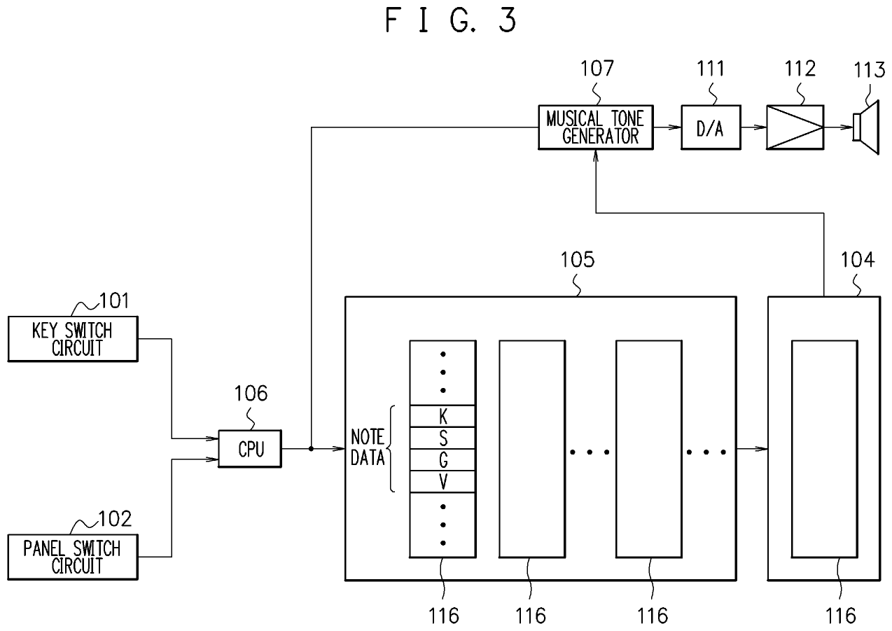

The ROM 105 stores programs and various data for controlling the entire automatic performing apparatus 100, as well as a plurality of performance data 116 corresponding to a plurality of songs and programs for a performance control function. A plurality of the performance data 116 are stored in the ROM 105 in advance for each song as illustrated in FIG. 3.

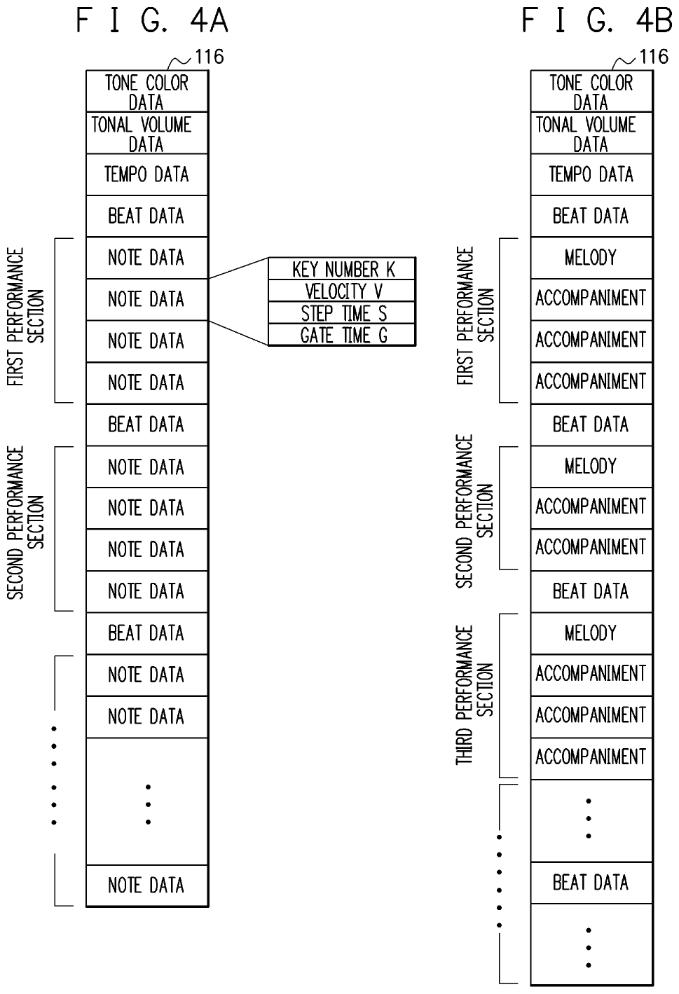

As illustrated in FIG. 4A, the automatic performance data 116 of each song include tone color data, tonal volume data, tempo data, and beat data at the beginning of the song. Further, the performance data 116 include pieces of note data set for each one beat and beat data correspondingly provided for each beat. The above-described tone color data are to designate the tone color of a musical tone to be generated based on the following note data (melody note data and accompaniment note data in FIG. 4(B)). The above-described tonal volume data are to control the tonal volume of a musical tone to be generated. The above-described tempo data are to control only the tempo speed of a first beat of the song. Incidentally, the tempos in and after the second beat are determined by the timing between key pressing events as will be described later.

Each piece of the above-described note data contain key number K, step time S, gate time G, and velocity V. The step time S is data indicating the timing of the note data whose tone is generated using the beginning of the song as a base point. The key number K represents a tone pitch. The gate time G represents the duration of tone generation. The velocity V represents the volume of a tone to be generated (pressure at which a key is pressed).

The performance data 116 are segmented into a plurality of performance sections. Each of a plurality of the performance sections is the length of one beat of the performance data 116, for example. Each of a plurality of the performance sections has a plurality of note data, for example.

Incidentally, as illustrated in FIG. 4B, each of a plurality of the performance sections may have, for example, melody note data and accompaniment note data. The melody note data and the accompaniment note data each contain key number K, step time S, gate time G, and velocity V.

The automatic performance mode includes a beat mode and a melody mode. In the beat mode, each of a plurality of the performance sections is the length of one beat of the performance data 116. In the melody mode, each of a plurality of the performance sections is a section consisting of one tone of melody note data in the performance data 116 and accompaniment note data accompanying the one tone of the melody note data.

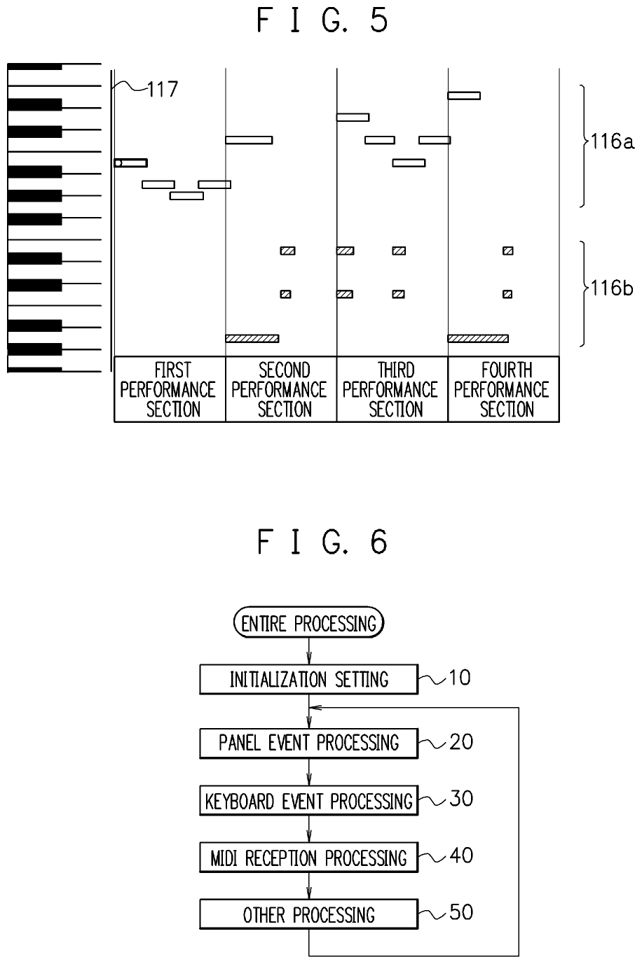

FIG. 5 is a view illustrating a display example of a piano roll during the first to fourth performance sections of the performance data 116 in the beat mode. The CPU 106 can display the piano roll in FIG. 5 on the indicator 109a. The performance data 116 include melody note data 116a and accompaniment note data 116b. Each of the first to fourth performance sections is the length of one beat.

The beat at the beginning of the song is 2/4. Pieces of note data from the first performance section to the fourth performance section are illustrated, one beat at a time from the beginning of the song. No note data exist on the first beat of the first bar. The first performance section is the second beat of the first bar and is only the pick-up beat of the first bar. The second performance section and the third performance section are the second bar. The fourth performance section is the first beat of the third bar. In this example, the duration of each performance section is the same as the length of a quarter note.

In the piano roll illustrated in FIG. 5, the horizontal direction of the display screen is the time axis of the performance data, and the vertical direction of the display screen is The pitch of the keyboard 108. The note data 116a and 116b are each represented by a rectangular figure. Of the rectangular figure, the left side indicates the start time of tone generation and the right side indicates the end time of the tone generation. A regeneration position 117 of the performance data is a song pointer indicated by a vertical line. The CPU 106 advances a regeneration elapsed time of the automatic performance of the performance data according to a key pressing operation of the keyboard 108, and performs scroll display so that the rectangular figure of each note data moves from right to left. When the left side of the rectangular figure of the note data passes through the regeneration position 117, generation of a musical tone is started. When the right side of the rectangular figure passes through the regeneration position 117, the generation L musical tone ends.

Returning to FIG. 1, the CPU 106 implements processing of the later-described automatic performing apparatus 100 by executing an automatic performing program stored in the RUM 105 in advance. The CPU 106 also controls the overall operation of the automatic performing apparatus 100 by reading and executing various control programs stored in tee RUM 105. At this time, the RAM 104 is used as a memory for temporarily storing various data for the CPU 106 to perform various pieces of control processing. During the automatic performance, as illustrated in FIG. 3, the RAM 104 holds the performance data 116 of the song to be automatically performed and sends them to the musical tone Generator 107 as needed.

The musical tone generator 107 is to generate a musical tone of the predetermined automatic performance data 116 sent from the RAM 104 at the time of execution of automatic performance, and generate a musical tone in response to key pressing of the keyboard 108 at the time of execution of normal performance.

Next, there is explained a basic operation of the automatic performing apparatus 100. In the case of the automatic performance mode, when a first key pressing event is provided, the automatic performing apparatus 100 advances the automatic performance from the beginning of the first performance section to the end of the first performance section in the automatic performance data, and when a second key pressing event is provided, the automatic performing apparatus 100 advances the automatic performance from the beginning of the second performance section to the end of the second performance section. In the same manner thereafter, when an nth key pressing event is provided, the automatic performing apparatus 100 advances the automatic performance from the beginning of an nth performance section to the end of the nth performance section.

FIG. 6 is a flowchart illustrating a main routine of processing or the automatic performing apparatus 100. When the automatic performing apparatus 100 is powered on, first, at Step 10, the CPU 106 performs initialization setting. This initialization setting is the processing to set the internal state of the CPU 106 to the initial state and set initial values in registers, counters, flags, or the like defined in the RAM 104. Further, in this initialization setting, the CPU 106 sends predetermined data to the musical tone generator 107 to perform processing to prevent unnecessary tones from being generated when the power is applied.

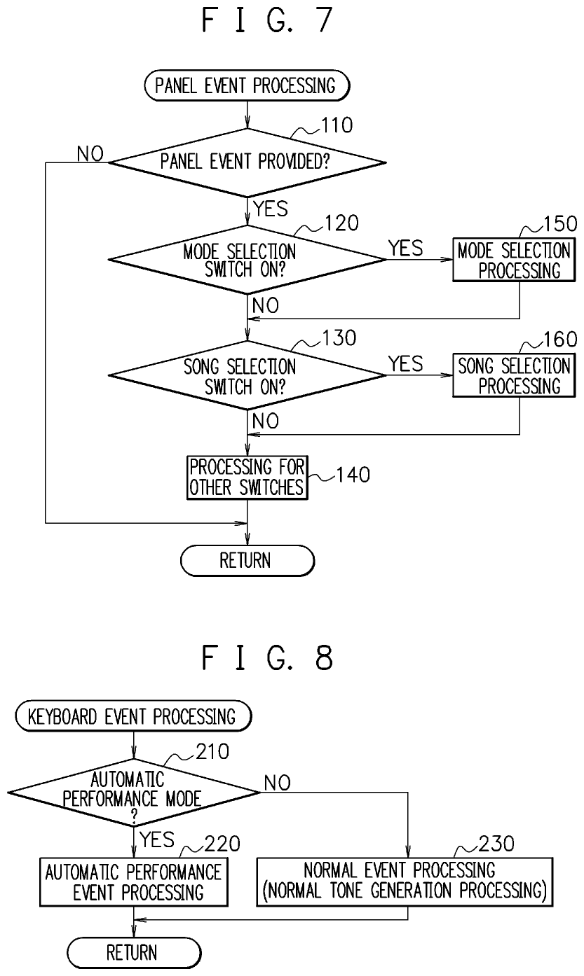

Then, at Step S20, the CPU 106 performs panel event processing. There are illustrated details of the panel event processing in FIG. 7.

At Step 110, the CPU 106 determines the presence or absence of an operation on the operation panel 109 by the panel switch circuit 102. This is performed as follows. That is, first, the CPU 106 takes in data indicating the on/off state of each switch obtained by the panel switch circuit 102 scanning the operation panel 109 (to be referred to as “new panel data” below) as a bit sequence corresponding to each switch.

Then, the CPU 106 makes a comparison between data previously read and already stored in the RAM 104 (to be referred no as “old panel data” below) and the above-described new panel data to create a panel event map in which different bits are turned on. The presence or absence of a panel event is determined by referring to this panel event map. That is, if there is even one bit that is on In the panel event map, it is determined that a panel event has been provided.

When determining that no panel event has been provided at Step S110, the CPU 106 returns from the routine of the panel event processing to the main routine in FIG. 6. On the other hand, when determining that the panel event has been provided at Step 110, the CPU 106 proceeds to Step 120.

At Step 120, the CPU 106 determines whether or not the panel event is the event of the mode selection switch. This is performed by checking whether or not the bit corresponding to the mode selection switch in the panel event map is on. After determining that the panel event is not the event of the mode selection switch, the CPU 106 proceeds to Step 130. On the other hand, when determining that the panel event is the event of the mode selection switch, the CPU 106 proceeds to Step 150.

At Step 150, the CPU 106 performs mode change processing. This mode change processing is the processing to switch between the normal performance mode and the automatic performance mode. After the mode change processing is finished, the CPU 106 proceeds to Step 130.

At Step 130, the CPU 106 determines whether or not the above-described panel event is the event of the song selection switch. This is performed by determining whether or not the bit corresponding to the song selection switch in the panel event map is on.

When determining that the panel event is not the event of the song selection switch, the CPU 106 proceeds to Step 140. On the other hand, when determining that the panel event is the event of the song selection switch, the CPU 106 proceeds to Step 160.

At Step 160, the CPU 106 performs song selection processing. This song selection processing is the processing to select a song to be automatically performed, and the song designated by the song selection switch is performed daring the execution of automatic performance. After the song selection processing is finished, the CPU 106 proceeds to Step 140.

At Step 140, the CPU 106 performs pieces of processing corresponding to other switches. By this “other switch processing,” for example, pieces of processing corresponding to panel events of a tone color selection switch, an acoustic effect selection switch, a tonal volume setting switch, and so on are performed. When this “other switch processing” is finished, the CPU 106 returns from the routine of the panel event processing to the main routine in FIG. 6.

Returning to FIG. 6, when the panel event processing is finished, at Step 30, the CPU 106 executes key pressing event processing. There are illustrated details of this key pressing event processing in FIG. 8.

First, at Step 210, the CPU 106 determines whether the mode is the automatic performance mode or the normal performance mode. When determining that the mode is the automatic performance mode, the CPU 106 proceeds to Step 220. On the other hand, when determining that the mode is the normal performance mode, the CPU 106 proceeds to Step 230.

At Step 220, the CPU 106 executes later-described automatic performance event processing and returns to the main routine in FIG. 6. At Step 230, the CPU 106 executes normal event processing (normal tone generation processing as an electronic musical instrument) and returns to the main routine in FIG. 6.

Returning to FIG. 6, at Step 40, the CPU 106 executes MIDI reception processing. Specifically, the CPU 106 performs tone generation processing, mute processing, or any other processing based on data input from an external device (not illustrated) connected via a MIDI terminal.

Then, at Step 50, the CPU 106 performs other processing. Specifically, the CPU 106 performs parameter setting processing of the musical tone generator 107 including tone color selection processing, volume setting processing, and so on.

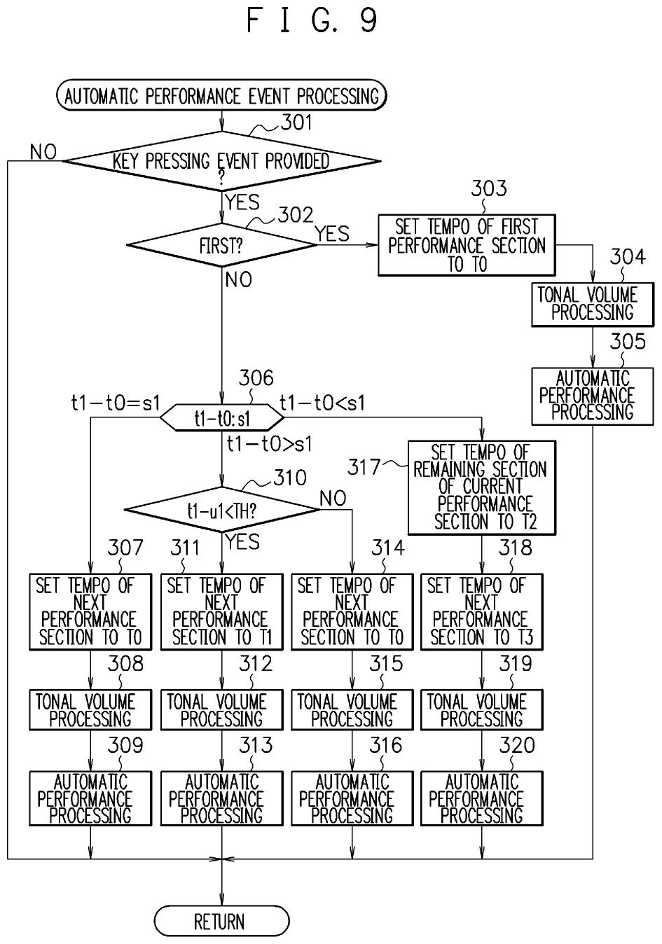

FIG. 9 is a flowchart illustrating details of the processing at Step 220 in FIG. 8. At Step 301, the CPU 106 determines whether or not a key pressing event (external event) has been provided. This is performed in the following manner. That is, the CPU 106 takes in data indicating the pressing state of each key (to be referred to as “new key data” below) as a bit sequence corresponding to each key by the key switch circuit 101 scanning the keyboard 108.

Then, the CPU 106 makes a comparison between data previously read and already stored in the RAM 104 (to be referred to as “old key data” below) and the above-described new key data to check whether or not there exist any different bits, thereby creating a key pressing event map in which the different bits are turned on. The presence or absence of a key pressing event is determined by referring to this key pressing event map. That is, if there is even one bit that is on in the key pressing event map, the CPU 106 determines that a key pressing event has been provided The key pressing event includes information on the key pressing speed of the keyboard 108. The information on key pressing speed is the information on the strength of a tone to be generated.

When determining that the key pressing event has been provided, the CPU 106 proceeds to Step 302. On the other hand, when determining that no key pressing event has been provided, the CPU 106 returns from the routine of the automatic performance event processing to the flowchart in FIG. 8.

At Step 302, the CPU 106 determines whether or not the above-described key pressing event is a first key pressing event KON1. When the above-described key pressing event is the first key pressing event KON1, the CPU 106 proceeds to Step 303, and when the above-described key pressing event is the second or subsequent key pressing event, the CPU 106 proceeds to Step 306.

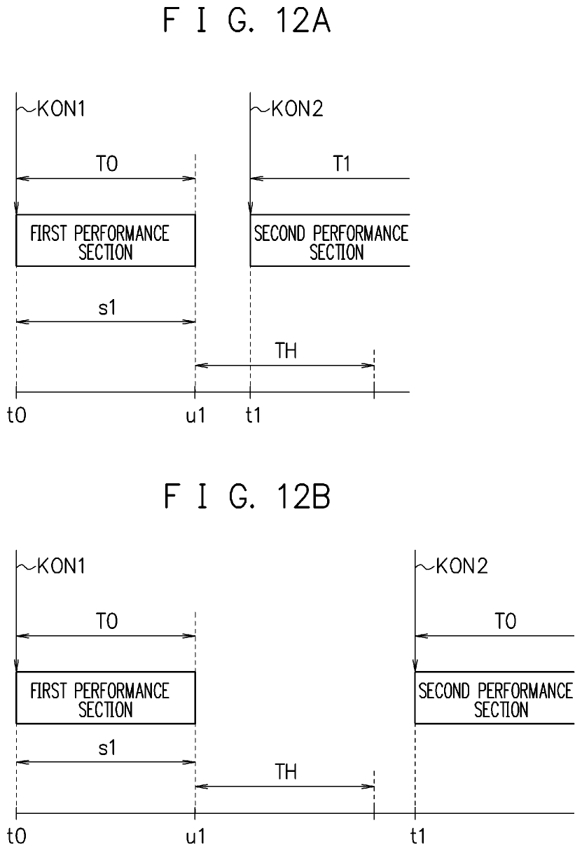

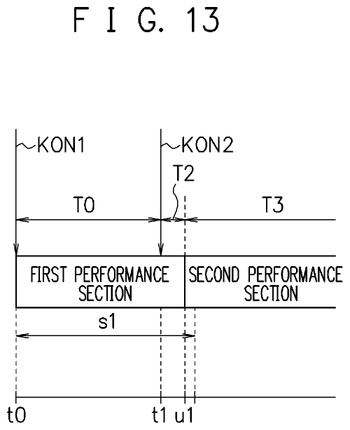

At Step 303, the CPU 106 sets the tempo of the first performance section to T0, as illustrated in FIG. 11, FIG. 12A, FIG. 12B, and FIG. 13. Here, the tempo T0 is the tempo indicated by the tempo data in FIG. 4A.

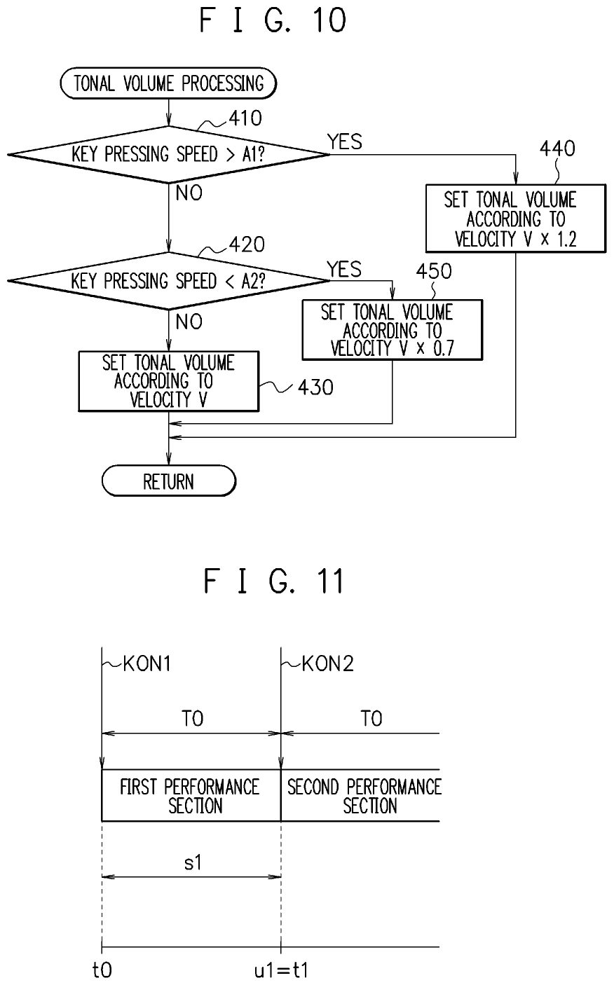

Then, at Step 304, the CPU 106 performs the tonal volume setting processing. The CPU 106 determines the tonal volume of the automatic performance in the first performance section based on the information on the key pressing speed included in the key pressing event KON1. Details of the tonal volume setting processing are illustrated in FIG. 10.

At Step 410, the CPU 106 determines whether or not the key pressing speed included in the key pressing event is larger than a predetermined value A1. When the key pressing speed is smaller than A1, the CPU 100 proceeds to Step 420, and when the key pressing speed is larger than A1, the CPU 106 proceeds to Step 440.

At Step 420, the CPU 106 determines whether or not the key pressing speed included in the key pressing event is smaller than a predetermined value A2. When the key pressing speed is larger than A2, the CPU 106 proceeds to Step 430, and when the key pressing speed. is smaller than A2, the CPU 106 proceeds to Step 450. Incidentally, A1>A2 is established.

At Step 430, the CPU 106 sets the tonal volume of a tone to be generated of the note data within the performance section corresponding to the key pressing event to the tonal volume according to the velocity V of each piece of the note data. Then, the processing returns to the flowchart in FIG. 9.

At Step 440, the CPU 106 sets the tonal volume of a tone to be generated of the note data within the performance section corresponding to the key pressing event to the tonal volume according to the value obtained by multiplying the velocity V of each piece of the note data by 1.2. Then, the processing returns to the flowchart in FIG. 9.

At Step 450, the CPU 106 sets the tonal volume of a tone to be generated of the note data within the performance section corresponding to The key pressing event to the tonal volume according to the value obtained by multiplying the velocity V of each piece of the note data by 0.7. Then, the processing returns to the flowchart in FIG. 9.

By pieces of the above-described processing at Steps 410 to 450, the performer can vary the tonal volume during the automatic performance in the performance section corresponding to the pressed key by varying the key pressing speed of the keyboard 108.

Returning to FIG. 9, at Step 305, the CPU 106 functions as an automatic performing unit and as illustrated in FIG. 11, FIG. 12A, FIG. 12B, and FIG. 13, performs the automatic performance of the performance data 116 in the first performance section at the tempo T0 in response to the input of the key pressing event KON1. Specifically, the CPU 106 sequentially reads the note data in the first performance section to send them to the musical tone generator 107. The musical tone generator 107 determines the pitch of a tone to be generated and the duration of tone generation according to the key number K and the gate time G, respectively, which are included in the note data. Further, the musical tone generator 107 sets the tonal volume of the tone to be generated according to the velocity V included in the note data and the key pressing speed of the keyboard 108, and generates the tone. Thereafter, the processing returns to the flowchart in FIG. 8.

At Step 306, as illustrated in FIG. 11, the CPU 106 proceeds to Step 307 when an interval t1−t0 between the key pressing events is the same as a performance time s1. The interval t1−t0 between the key pressing events is the time from an input time t0 of the previous key pressing event KON1 to an input time t1 of a current key pressing event KON2. The performance time s1 is the performance time when the performance is performed at the tempo T0 in the entire first performance section, which is the target of the current automatic performance. That is, the CPU 106 proceeds to Step 307 when a time u1 at which the automatic performance in the first performance section, which is the target of the current automatic performance, is finished is the same as the input time t1 of the current key pressing event KON2.

At Step 307, the CPU 106 sets the tempo of the next performance section to the same tempo as the tempo of the performance section, which is the target of the current automatic performance. When the key pressing event KON2 is input, for example, the CPU 106 sets the tempo of the second performance section to the same tempo as the tempo T0 of the first performance section.

Then, at Step 308, the CPU 106 performs the tonal volume setting processing based on the current key pressing event KON2. This tonal volume setting processing is the processing of the flowchart in FIG. 10, and is the same as explained above. The CPU 106 determines the tonal volume of the automatic performance in the second performance section based on the information on the key pressing speed included in the key pressing event KON2.

Then, at Step 309, as illustrated in FIG. 11, the CPU 106 performs the automatic performance in the second performance section at the tempo T0 set at Step 307. A specific automatic performance method is the same as at Step 305 described above. Thereafter, the processing returns to the flowchart in FIG. 8.

At Step 306, as illustrated in FIG. 12A or FIG. 12B, the CPU 106 proceeds to Step 310 when the interval t1−t0 between the key pressing events is longer than the performance time s1. The interval t1−t0 between the key pressing events is the time from the input time t0 of the previous key pressing event KNO1 to the input time t1 of the current key pressing event KON2. The performance time s1 is the performance time when the performance is performed at the tempo T0 in the entire first performance section, which is the target of the current automatic performance. That is, the CPU 106 proceeds to Step 310 when the current key pressing event KON2 is input at the time t1 after the time u1 at which the automatic performance in the first performance section, which is the target of the current automatic performance, is finished.

At Step 310, as illustrated in FIG. 12A, the CPU 106 proceeds to Step 311 when the current key pressing event KON2 is input at the time t1 before a predetermined period TH elapses after the time u1 at which the automatic performance in the first performance section, which is the target of the current automatic performance, is finished. The predetermined period TH is the period corresponding to the performance time s1. For example, the predetermined period TH is the length of one beat of the performance data 116.

At Step 311, the CPU 106 calculates a tempo T1 of the second performance section, which is the target of the next automatic performance, according to the tempo T0 of the first performance section, which is the target of the current automatic performance, the performance time s1 when the performance is performed at the tempo T0 in the entire first performance section, and the time t1−t0 from the input of the previous key pressing event KON1 to the input of the current key pressing event KON2, as in. Equation (1). The tempo T1 is a tempo different from the tempo T0.

T1=T0×s1÷(t1−t0) (1)

For example, each performance section is the length of one beat, and the length of one beat is the same as the length of a quarter note. A time unit (tick) of the performance data 116 is, for example, the unit of a length d of a quarter note (time base)=480. When the performance time s1 (second) is c1 (tick), the performance time s1 (second) is expressed by Equation. (2) based on the tempo T0. The tempo T0 is 120, for example. The tempo in this embodiment is represented by the number of beats of a quarter note in one minute. Tempo=120 is the speed of the performance that strikes 120 beats per minute with the length of a quarter note.

$$\begin{matrix}s 1 = c 1 ( tick ) \div d ( tick ) \times 60 ( seconds ) \div T 0 \\ = 480 \div 480 \times 60 \div 120 \\ = 0.5 seconds\end{matrix} \qquad ( 2 )$$

For example, when (t1−t0) is 0.75 seconds, the tempo T1 of the second performance section is 80 by Equation (3) based on Equation (1). The tempo T1 of the second performance section is slower than the tempo T0 of the first performance section.

$$\begin{matrix}T 1 = T 0 \times s 1 \div ( t 1 - t 0 ) \\ = 120 \times 0.5 \div 0.75 \\ = 80\end{matrix} \qquad ( 3 )$$

Then, at Step 312, the CPU 106 performs the tonal volume setting processing based on the current key pressing event KON2. This tonal volume setting processing is the processing of the flowchart in FIG. 10, and is the same as explained above.

Then, at Step 313, as illustrated in FIG. 12A, the CPU 106 performs the automatic performance in the second performance section at the tempo T1 set at Step 311. A specific automatic performance method is the same as at. Step 305 described above. Thereafter, the processing returns to the flowchart in FIG. 8.

At Step 310, the CPU 106 proceeds to Step 314 when the current key pressing event KON2 is input at the time t1 after the predetermined period TH elapses after the time u1 at which the automatic performance in the first performance section, which is the target of the current automatic performance, is finished, as illustrated in FIG. 125. For example, the predetermined period TH is the length of one beat of the performance data 116.

At Step 314, the CPU 106 sets the tempo of the next performance section to the same tempo as the tempo of the performance section, which is the target of the current automatic performance, or to the tempo of the performance data 116. When the key pressing event KON2 is input, for example, the CPU 106 sets the tempo of the second performance section to the same tempo as the tempo T0 of the first performance section or the tempo T0 of the second performance section of the performance data 116 in FIG. 4A.

Then, at Step 315, the CPU 106 performs the tonal volume setting processing based on the current key pressing event KON2. This tonal volume setting processing is the processing of the flowchart in FIG. 10, and is the same as explained above.

Then, at Step 316, the CPU 106 performs the automatic performance in the second performance section at the tempo T0 set at Step 314 as illustrated in FIG. 12B. A specific automatic performance method is the same as at Step 305 described above. Thereafter, the processing returns to the flowchart in FIG. 8,

Incidentally, it the predetermined period TH at Step 310 is too short, as illustrated in FIG. 12B, the tempo is restored to the original tempo T0 each time there is a pause at the time u1. Therefore, a lower limit threshold value (0.2 seconds) is preferably set for the predetermined period TH. Incidentally, the lower limit threshold value may be a value other than 0.2 seconds.

The predetermined period TH is the length of one beat of the performance data 116, for example. When the length of one beat of the performance data 116 is longer than the threshold value (0.2 seconds), the predetermined period TH is the length of one beat of the performance data 116. Further, when the length of one beat of the performance data 116 is shorter than the threshold value (0.2 seconds), the predetermined period TH is the threshold value (0.2 seconds).

At Step 306, the CPU 106 proceeds to Step 317 when the interval t1−t0 between the key pressing events is shorter than the performance time s1, as illustrated in FIG. 13. The interval t1−t0 between the key pressing events is the time from the input time t0 of the previous key pressing event KON1 to the input time t1 of the current key pressing event KON2. The performance time s1 is the performance time when the performance is performed at the tempo T0 in the entire first performance section, which is the target of the current automatic performance. That is, the CPU 106 proceeds to Step 317 when the current key pressing event KON2 is input at the time t1 before the automatic performance the first performance section, which is the target of the current automatic performance, is finished.

At Step 317, the CPU 106 sets the tempo of the remaining section of the performance section, which is the target of the current automatic performance, to the tempo T2. When the key pressing event KON2 is input, for example, the CPU 106 sets the tempos at the remaining times t1 to u1 of: the first performance section to the tempo T2. The tempo T2 is a tempo different from the tempo T0.

The CPU 106 calculates the tempo T2 according to the tempo T0 of the first performance section, which is the target of the current automatic performance, the performance time s1 when the performance is performed at the tempo T0 in the entire first performance section, and the time t1−t0 from the input of the previous key pressing event KON1 to the input of the current key pressing event KON2, as in Equation (4).

T2−T0×s1÷(t1−t0) (4)

For example, when (t1−t0) is 0.3 seconds, the tempo T2 is 200 by Equation (5) based on Equation (4). The tempo T2 is faster than the tempo T0. In the first performance section, the tempo is T0 at the times t0 to t1, and is T2 at the times t1 to u1.

$$\begin{matrix}T 2 = T 0 \times s 1 \div ( t 1 - t 0 ) \\ = 120 \times 0.5 \div 0.3 \\ = 200\end{matrix} \qquad ( 5 )$$

Incidentally, a lower limit threshold value B1 is preferably set for the tempo T2. This is because as the times t1 to u1 until the end of the first performance section are longer, the performance from the beginning of the next second performance section is delayed from the time t1 of the key pressing event KON2, resulting in poor followability of the automatic performance. An allowable time of the time t1−u1 from the input of the key pressing event KON2 to the end of the first performance section is set to s3 (second). The time u1 at which the second performance section starts is limited so as not to be delayed by the allowable time s3 or more from the time t1 of the key pressing event KON2.

The allowable time s3 is desirably proportional to the tempo T0 of the first performance section. That is, the allowable time s3 may be longer as the tempo T0 is slower. Further, the allowable time s3 is easily understood when the allowable time s3 is determined based on an allowable note value n (tick). For example, when the allowable note value n (tick) is set to the length of an eighth note, the allowable note value n (tick) is the length (240 ticks), which is half the length d (tick) of the quarter note. The allowable time s3 is expressed by Equation (6).

$$\begin{matrix}s 3 ( second ) = n ( tick ) \div d ( tick ) \times 60 ( second ) \div T 0 \\ = 240 \div 480 \times 60 \div 120 \\ = 0.25 seconds\end{matrix} \qquad ( 6 )$$

The lower limit threshold value B1 of the tempo T2 is expressed by Equation (7) based on the allowable time s3.

$$\begin{matrix}B 1 = c 1 ( tick ) \div d ( tick ) \times 60 ( second ) \div s 3 ( second ) \\ = c 1 ( tick ) \div d ( tick ) \times 60 ( second ) \div \{ n ( tick ) \div \\ d ( tick ) \times 60 ( second ) \div T 0 \} \\ = T 0 \times c 1 ( tick ) \div n ( tick ) \\ = 1 \; 20 \times 480 \div 240 \\ = 240\end{matrix} \qquad ( 7 )$$

When the tempo T2 calculated by Equation (4) is smaller than the lower limit threshold value B1, the CPU 106 modifies the tempo T2 calculated by Equation (4) to the lower limit threshold value B1. Since the tempo T2 (=200) calculated by Equation (5) is smaller than the lower limit threshold value B1 (=240), for example, the CPU 106 modifies the tempo 22 calculated by Equation (5) to 240. By setting the lower limit threshold value B1, the time from the input time t1 of the key pressing event KON2 to the time u1 at which the automatic performance in the second performance section starts can be shortened, and the delay time for the automatic performance start in response to the key pressing operation can be shortened.

Next, there is explained an example where the interval t1−t0 between the key pressing events is 0.2 seconds. In this case, the CPU 106 calculates the tempo T2 by Equation (8) based on Equation (4).

$$\begin{matrix}T 2 = T 0 \times s 1 \div ( t 1 - t 0 ) \\ = 120 \times 0.5 \div 0.2 \\ = 300\end{matrix} \qquad ( 8 )$$

In this case, the CPU 106 sets the tempo T2=300 because the tempo T2 (=300) is faster than the lower limit threshold value B1 (=240).

Incidentally, the allowable time s3 in Equation (6) may be set to a fixed value (for example, 0.1 seconds, or the like) regardless of the tempo T0, or it may be set by a setting means. The allowable time s3 is preferred to be about 0.1 seconds, which is the level at which the operator does not feel that the followability to the key pressing timing is poor.

Then, at Step 318, the CPU 106 sets the tempo of the performance section, which is the target of the next automatic performance, to a tempo T3 as illustrated in FIG. 13. When the key pressing event KON2 is input, for example, the CPU 106 sets the tempo of the second performance section to the tempo T3.

The CPU 106 calculates the tempo T3 by Equation (9). Here, a coefficient f is a decimal from 0 to 1.0.

T3=T2×f+T0×(1−f) (9)

The coefficient f is a coefficient for smoothing the tempo shift from the tempo T0 to the tempo T1. As the coefficient f is smaller, the tempo T3 is more likely to follow the tempo T0 of the previous performance section. As the coefficient f is larger, the tempo T2 is more likely to shift to the tempo T2 based on the interval t1−t0 between he key pressing events. The tempo T3 is likely to shift to the tempo T2 based on the interval t1−t0 between the key pressing events. When 0<f<1.0 is established, the tempo T3 is faster than the tempo T0, and is slower than the tempo T2.

There is explained the case where the coefficient f is 0.8 and the interval t1−t between the key pressing events is 0.4 seconds, for example. In this case, the tempo T3 is expressed by Equation (10) based on Equation (9). The tempo T3 of the second performance section is 140.

$$\begin{matrix}T 3 = T 2 \times f + T 0 \times ( 1 - f ) \\ = \{ T 0 \times s 1 \div ( t 1 - t 0 ) \} \times f + T 0 \times ( 1 - f ) \\ = \{ 120 \times 0.5 \div 0.4 \} \times 0.8 + 120 \times ( 1 - 0.8 ) \\ = 150 \times 0.8 + 120 \times ( 1 - 0.8 ) \\ = 140\end{matrix} \qquad ( 10 )$$

Then at Step 319, the CPU 106 performs the tonal volume setting processing based on the current key pressing event KON2. This tonal volume setting processing is the processing of the flowchart in FIG. 10, and is the same as explained above.

Then, at Step 320, the CPU 106 continues the automatic performance in the first performance section at the tempo T2 set at Step 317, as illustrated in FIG. 13. The tempo T2 is a tempo different from the tempo T0. At the time u1, the CPU 106 finishes the automatic performance in the first performance section at the tempo T2, and performs the automatic performance in the second performance section at the tempo T3 set at Step 318. A specific automatic performance method is the same as at Step 305 described above. Thereafter, the processing returns to the flowchart in FIG. 8.

Although the first performance section and the second performance section have been explained above as an example, the same processing is performed for the shift to the third performance section. In this case, the above-described tempo T0 indicates the tempo of the previous performance section.

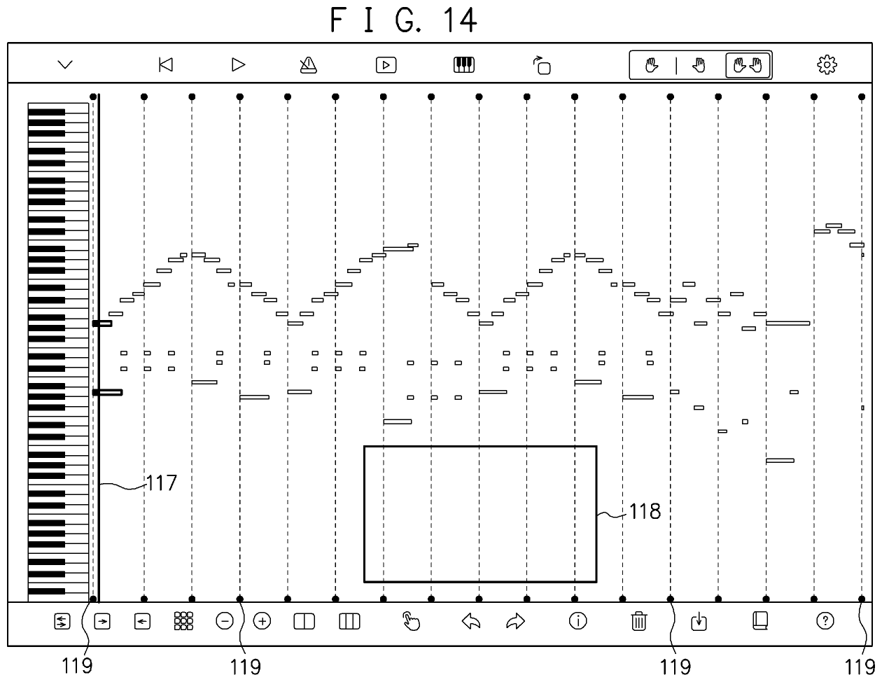

FIG. 14 is a view illustrating an example of a piano roll to be displayed on a touch panel. When the automatic performing apparatus 100 in FIG. 1 is a tablet, the operation panel 109 is a touch panel, and the CPU 106 can display the piano roll in FIG. 14 on the touch panel of the operation panel 109 as n FIG. 5. Further, when the automatic performing apparatus 100 in FIG. 1 is an electronic musical instrument, the operation panel 109 includes a touch panel, and the CPU 106 can display the piano roll in FIG. 14 on the touch panel of the operation panel 109 as in FIG. 5.

The piano roll in FIG. 14 includes a plurality of pieces of note data of performance data and a regeneration position 117 similarly to the piano roll in FIG. 5. A plurality of pieces of the note data of the performance data are segmented by a plurality of dashed lines 119 of performance sections. Each of a plurality of the performance sections is, for example, the length of one beat of the performance data.

The piano roll in FIG. 14 further includes a tap area 118. The above-described key pressing events KON1 and KON2 are examples of the external event. In place of the above-described key pressing events KON1 and KON2, other external events can be use. The external event is an event based on a key pressing operation on the keyboard 108, an operation on an operation element or a touch panel of the operation panel 109, or the like. Here, there is explained an example of a tap event based on a tap operation on the tap area 118 as another example of the external event. That is, in the automatic performance mode, the tap operation on the tap area 118 can be used in place of the key pressing operation of the keyboard 108 described above.

The CPU 106 creates a tap event based on the tap operation on the tap area 118 The tap event includes information on the strength of a tone to be generated. The information on the strength of a tone to be generated corresponds to the key pressing speed of the keyboard 108 in FIG. 10. The CPU 106 sets the tempo of each performance section based on the input time of the tap event of the tap area 118 in the same manner as described above.

The above-described information on the strength of a tone to be generated is information on the strength of tapping of the tap area 118. As the tap area 118 is tapped harder, the tone is generated stronger. Here the tapping strength also includes a tapping speed (time from tap-on to tap-off), and so on. Alternatively, the above-described information on the strength of a tone to be generated may be information on a tap position within the tap area 118. For example, as the tap position in the tap area 118 is located higher, the tone is generated stronger, and as the tap position in the tap area 118 is located lower, the tone is generated weaker. Besides, the strength of a tone to be generated may be input by swiping (distance, direction, speed, or the like), another different touch gesture, or the like. In short, if the strength of a tone to be generated can be controlled by the difference in the touch operation, this embodiment is not limited to the above. Thereby, the CPU 106 creates a tap event including the information on the strength of a tone to be generated based on one tap operation by the operator. The CPU 106 performs pieces of the processing in FIG. 9 and FIG. 10 using the information on the strength of a tone to be generated and the tap event in place of the above-described key pressing speed and key pressing event.

Next, the effects of this embodiment are explained. In Patent Document 1, when the key pressing event KON2 is input after automatically performing the first and second note data within the first performance section in FIG. 5, automatic performance in the second performance section is started without automatically performing the third and fourth note data in the first performance section. This is a major musical problem because the tones of the original song are performed while being thinned out.

Then, in this embodiment, when the key pressing event KON2 is input before the automatic performance in the first performance section is finished, the CPU 106 changes the tempo T0 to the faster tempo T2 and continues the automatic performance in the first performance section as illustrated in FIG. 13. When the automatic performance in the first performance section is finished, the CPU 106 switches the tempo to the new tempo T3 with the tempos T0 and T2 added, and performs the automatic performance in the second performance section.

According to this embodiment, the CPU 106 can eliminate the note data whose tones are not generated while at least maintaining the followability of automatic performance in response to key pressing, thus solving the problem of Patent Document 1 described above.

Further, in Patent Document 1, when the key pressing event is input before the automatic performance in the first performance section is finished, the performance position immediately jumps to the beginning of the second performance section, the tempo suddenly becomes fast from the beginning of the second performance section, and the performance immediately reaches the end of the second performance section and pauses, thus causing a problem of unnatural performance against the operator's will.

Thus, according to this embodiment, the CPU 106 sets the new tempo T3 with the tempos T0 and T2 added for the second performance section, thereby making it possible to prevent the tempo from suddenly becoming fast and solve the problem of Patent Document 1 described above. The tempo T3 can be faster than the tempo T0 and slower than the tempo T2.

Further, in FIG. 12A, when the interval t1−t0 between the key pressing events is extremely long, the tempo T1 of the second performance section becomes extremely slow, causing a problem of unnatural performance.

Thus, as illustrated in FIG. 12B, when the key pressing event KON2 is input after the predetermined period TH elapses after the time u1 at which the automatic performance in the first performance section is finished, the CPU 106 ignores the interval t1−t0 between the key pressing events and sets the tempo to the tempo T0 of the performance data 116, or the tempo T0 of the previous performance section, for the second performance section. This prevents the tempo of the second performance section from becoming extremely slow, even when the interval t1−t0 between the key pressing events is extremely long, thereby making it possible to solve the above-described problem.

This embodiment can be implemented by a computer executing a program. Further, a computer-readable recording medium recording the above-described program and a computer program product such as the above-described program can also be applied as the embodiment of the present invention. As the recording medium, for example, a flexible disk, a hard disk, an optical disk, a magneto-optical disk, a CD-ROM, a magnetic tape, a nonvolatile memory card, a ROM, and so on can be used.

According to the present invention, when an external event is input before the automatic performance in the performance section is finished, it is possible to continue the automatic performance in the performance section at an appropriate tempo.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

What is claimed is:

1. An automatic performing apparatus being an automatic performing apparatus that automatically performs performance data segmented into a plurality of performance sections, the apparatus comprising:
a first automatic performing unit configured to perform automatic performance of the performance data in a first performance section at a first tempo in response to an input of a first external event; and
a second automatic performing unit configured to, when a second external event is input before the automatic performance in the first performance section is finished, continue the automatic performance in the first performance section at a second tempo different from the first tempo, the second automatic performing unit configured to, when the automatic performance in the first performance section is finished, perform automatic performance of the performance data in a second performance section at a third tempo.

2. The automatic performing apparatus according to claim 1, further comprising:
a third automatic performing unit configured to, when a second external event is input after the automatic performance in the first performance section is finished, perform automatic performance of the performance data in a second performance section at a fourth tempo different from the first tempo.

3. The automatic performing apparatus according to claim 2, wherein
the third automatic performing unit is configured to,
when she second external event is input before a first period elapses after the automatic performance in the first performance section is finished, perform the automatic performance in the second performance section at the fourth tempo, and
the third automatic performing unit is configured to,
when the second external event is input after the first period elapses after the automatic performance in the first performance section is finished, perform the automatic performance in the second performance section at the first tempo or a tempo of the performance data.

4. The automatic performing apparatus according to claim 3, further comprising:
a fourth automatic performing unit configured to, when the time at which the automatic performance in the first performance section is finished and the time at which the second external event is input are the same as each other, perform the automatic performance in the second performance section at the first tempo.

5. The automatic performing apparatus according to claim 1, wherein
the second automatic performing unit is configured to calculate the second tempo according to the first tempo, a performance time when the performance is performed at the first tempo in the entire first performance section, and a time from the input of the first external event to the input of the second external event.

6. The automatic performing apparatus according to claim 5, wherein
the second automatic performing unit is configured to, when the calculated second tempo is smaller than a first threshold value, modify the second tempo to the first threshold value.

7. The automatic performing apparatus according to claim 1, wherein
the second tempo is faster than the first tempo, and
the third tempo is faster than the first tempo and is slower than the second tempo.

8. The automatic performing apparatus according to claim 2, wherein
the third automatic performing unit is configured to calculate the fourth tempo according to the first tempo, a performance time when the performance is performed at the first tempo in the entire first performance section, and a time from the input of the first external event to the input of the second external event.

9. The automatic performing apparatus according to claim 2, wherein
the fourth tempo is slower than the first tempo.

10. The automatic performing apparatus according to claim 3, wherein
the first period is the length of one heat of the performance data.

11. The automatic performing apparatus according to claim 3, wherein
when the length of one beat of the performance data is longer than a second threshold value, the first period is the length of one beat of the performance data, and
when the length of one heat of the performance data is shorter than the second threshold value, the first period is the second threshold value.

12. The automatic performing apparatus according to claim 1, wherein
each of a plurality of the performance sections the length of one beat of the performance data.

13. The automatic performing apparatus according to claim 1, wherein
each of a plurality of the performance sections is a section consisting of one tone of melody note data of the performance data and accompaniment note data accompanying the one tone of the melody note data.

14. The automatic performing apparatus according to claim 1, wherein
the first external event and the second external event each are an event based on a key pressing operation on a keyboard or an operation on an operation element or a touch panel.

15. The automatic performing apparatus according to claim 1, wherein
the first external event and the second external event each include information on the strength of a tone to be generated,
the first automatic performing unit is configured to determine a tonal volume of automatic performance in the first performance section based on the information on the strength of a tone to be generated that is included in the first external event, and
the second automatic performing unit is configured to determine a tonal volume of automatic performance in the second performance section based on the information on the strength of a tone to be generated that is included in the second external event.

16. An automatic performing apparatus being an automatic performing apparatus that automatically performs performance data segmented into a plurality of performance sections, the apparatus comprising:
a first automatic performing unit configured to perform automatic performance of the performance data in a first performance section at a first tempo in response to an input of a first external event; and
a second automatic performing unit configured to, when a second external event is input before a first period elapses after the automatic performance in the first performance section is finished, perform automatic performance of the performance data in a second performance section at a second tempo different from the first tempo, the second automatic performing unit configured to, when the second external event is input after the first period elapses after the automatic performance in the first performance section is finished, perform the automatic performance of the performance data in the second performance section at the first tempo or a tempo of the performance data in the second performance section.

17. The automatic performing apparatus according to claim. 16, wherein
the second automatic performing unit is configured to calculate the second tempo according to the first tempo, a performance time when the performance is performed at the first tempo in the entire first performance section, and a time from the input of the first external event to the input of the second external event.

18. The automatic performing apparatus according to claim 16, wherein
the second tempo is slower than the first tempo.

19. The automatic performing apparatus according to claim 16, wherein
the first period is the length of one beat of the performance data.

20. The automatic performing apparatus according to claim 16, wherein
when the length of one beat of the performance data is longer than a second threshold value, the first period is the length of one beat of the performance data, and
when the length of one heat of the performance data is shorter than the second threshold value, the first period is the second threshold value.

21. A computer-readable non-transitory recording medium having stored therein an automatic performing program causing a computer to function as the automatic performing apparatus according to claim 1.
